(19) United States
(12) Patent Application Publication
(10) Pub. No.: US 2003/0152775 A1
(43) Pub. Date: Aug. 14, 2003

(54) Multilayered article of manufacture

(76) Inventors: Rudiger Gorny, Krefeld (DE); Siegfried Anders, Koln (DE); Wolfgang Nising, St. Augustin (DE); Jurgen Rohner, Koln (DE); Marco Roelofs, Krefeld (DE)

Correspondence Address: BAYER POLYMERS LLC, 100 BAYER ROAD, PITTSBURGH, PA, 15205, US

(21) Appl. No.: 10/308,785

(22) Filed: Dec. 3, 2002

(30) Foreign Application Priority Data
Dec. 4, 2001 (DE) 10159373.2

(51) Int. Cl. B32B 27/36

(52) U.S. Cl. 428/412

(57) ABSTRACT

A multilayered article of manufacture is disclosed. The article comprising a layer containing polycarbonate and a layer containing a copolyester. The repeating units of the copolyester are derived from dicarboxylic acids and from diols, where the repeating units derived from dicarboxylic acids contain 50 to 100% of units derived from terephthalic acid, 0 to 50% of units derived from isophthalic acid and 0 to 10% of units derived from other dicarboxylic acids, the sum of the proportions of the repeating units derived from terephthalic acid, isophthalic acid and other dicarboxylic acids is 100%, the percents being relative to the molar amount of the dicarboxylic acids. The repeating units derived from diols contain 0 to 97% of units derived from ethylene glycol, 0 to 97% of units derived from cyclohexanedimethanol and 0 to 3% of units derived from diethylene glycol and 0 to 10% of units derived from other diols, where the sum of the proportions of the repeating units derived from ethylene glycol, cyclohexanedimethanol, diethylene glycol and other diols is 100%, the percents being relative to the molar amount of diols. Also disclosed is a process for the production of the multilayered article of manufacture.

### FIELD OF THE INVENTION

The present invention relates to an article of manufacture and more particularly to a multilayered plastic article and a method for its manufacture.

### SUMMARY OF THE INVENTION

A multilayered article of manufacture is disclosed. The article comprising a layer containing polycarbonate and a layer containing a copolyester. The repeating units of the copolyester are derived from dicarboxylic acids and from diols, where the repeating units derived from dicarboxylic acids contain 50 to 100% of units derived from terephthalic acid, 0 to 50% of units derived from isophthalic acid and 0 to 10% of units derived from other dicarboxylic acids, the sum of the proportions of the repeating units derived from terephthalic acid, isophthalic acid and other dicarboxylic acids is 100%, the percents being relative to the molar amount of the dicarboxylic acids. The repeating units derived from diols contain 0 to 97% of units derived from ethylene glycol, 0 to 97% of units derived from cyclohexanedimethanol and 0 to 3% of units derived from diethylene glycol and 0 to 10% of units derived from other diols, where the sum of the proportions of the repeating units derived from ethylene glycol, cyclohexanedimethanol, diethylene glycol and other diols is 100%, the percents being relative to the molar amount of diols. Also disclosed is a process for the production of the multilayered article of manufacture.

### BACKGROUND OF THE INVENTION

Polycarbonate may not be used in some applications because its chemical resistance is inadequate.

Polyesters and copolyesters may not be used in some applications because their impact strength is inadequate.

Chemically resistant products, especially chemically resistant sheets, are therefore conventionally not made of polycarbonate in the prior art, but of PET (polyethylene terephthalate) or other polyesters or PMMA (polymethyl methacrylate). If, however, polycarbonate is presently used, then either a more chemically resistant coating is applied or a film of a more resistant material is laminated on or polycarbonate blends are used, which, in many cases, are either not transparent or exhibit haze. Transparent polycarbonate blends known in the prior art have the disadvantage of having notched impact strengths clearly lower than those of polycarbonate.

Multilayered products are known.

EP-A 0 110 221 discloses sheets consisting of two layers of polycarbonate, one of the layers containing at least 3 wt. % of a UV absorber. These sheets may be prepared by coextrusion.

EP-A 0 320 632 discloses moldings consisting of two layers of thermoplastic polymer, preferably polycarbonate, one of the layers containing special substituted benzotriazoles as UV absorbers. EP-A 0 320 632 also discloses the production of these moldings by coextrusion.

EP-A 0 247 480 discloses multilayered sheets in which, in addition to a layer of thermoplastic polymer, a layer of branched polycarbonate is present, the polycarbonate layer containing special substituted benzotriazoles as UV absorbers. The production of these sheets by coextrusion is also disclosed.

EP-A 0 500 496 discloses polymer compositions that are stabilized against UV light with special triazines and their use as an external layer in multilayered systems. Polycarbonate, polyesters, polyamides, polyacetals, polyphenylene oxide and polyphenylene sulfide are mentioned as polymers.

EP-A 0 825 226 discloses compositions of polycarbonate, substituted aryl phosphites and substituted triazines. EP-A 0 825 226 also discloses multilayered sheets in which one layer consists of the above-mentioned composition.

U.S. Pat. No. 5,709,929 and U.S. Pat. No. 5,654,083 disclose multilayered plastics sheets containing a layer of a special copolyester and a second layer of the same copolyester, the second layer containing a UV absorber.

JP-A 02 028 239 discloses a film of polyvinylidene fluoride and a polymethacrylate. A disadvantage of the film is that polyvinylidene fluoride is expensive.

JP-A 11 323 255, for example, discloses a siloxane paint with perfluoroalkyl additives, which can be applied on to polycarbonate to make this more chemically resistant.

U.S. Pat. No. 6,011,124 discloses a polymer mixture (blend) of a polyester and a polycarbonate. This blend has the advantage that it is more chemically resistant than polycarbonate. This blend has the disadvantage that it possesses lower notched impact strength than polycarbonate.

WO 98/19862 discloses multilayered sheets containing UV absorbers and optical brighteners in one layer.

U.S. Pat. No. 4,861,630 describes films of polycarbonate that are coextruded with semi-crystalline polyesters. The polyesters are e.g. PET or PBT. In contrast to the present invention, these polyesters are semi-crystalline and not amorphous.

JP-A 3 176 145 describes films of polycarbonate, which are coextruded with polyesters of ethylene glycol, terephthalic acid and isophthalic acid.

JP-A 5 212 841 describes films of polycarbonate, which are coextruded with polyesters.

An object exists of providing multilayered products having high chemical resistance and good mechanical properties. It is on this object that the present invention is based.

### DETAILED DESCRIPTION OF THE INVENTION

This object is achieved by providing a multilayered article comprising a layer containing polycarbonate and a layer containing a copolyester, wherein the repeating units of the copolyester are derived from dicarboxylic acids and from diols, wherein, of the repeating units that are derived from dicarboxylic acids,

50 to 100 mole % are derived from terephthalic acid and 0 to 50 mole % are derived from isophthalic acid and 0 to 10 mole % are derived from other dicarboxylic acids,

and wherein

the sum of the quantity of the repeating units derived from terephthalic acid and derived from isophthalic acid and derived from the other dicarboxylic acids is 100 mole %,

and wherein,

of the repeating units that are derived from diols, 0 to 97 mole % are derived from ethylene glycol and 0 to 97 mole % are derived from cyclohexanedimethanol and 0 to 3 mole % are derived from diethylene glycol and 0 to 10 mole % are derived from other diols,

and wherein

the sum of the quantity of the repeating units derived from ethylene glycol and from cyclohexanedimethanol and from diethylene glycol and from the other diols is 100 mole %

Amorphous copolyesters are preferred.

The present invention provides this multilayered product.

The present invention also provides a process for the production of this multilayered product by coextrusion.

The present invention also provides a product containing the aforesaid multilayered product. This product containing the aforesaid multilayered product is preferably selected from the group consisting of glazing, protective screen, conservatory, veranda, carport, bus shelter, advertising board, display case, window, partition, pay booth, inspection glass, display and roofing.

The glazing mentioned may be glazing for e.g. cars or greenhouses or filling stations or laboratories or chemical works.

The protective screens mentioned may be e.g. protective screens in laboratories.

The protective screens mentioned may be used for example as housings for machinery to protect against flying parts that might come loose. These protective screens are used e.g. as substitutes for steel cages.

The inspection glasses mentioned may be e.g. inspection glasses in counters or display cases. The inspection glasses mentioned may be used e.g. in the foodstuffs sector.

The definition of the proportions of the repeating units in the copolyester according to the invention and used for the present invention is as follows. A proportion of n mole % means a proportion of n mole % based on the sum of the proportions of all repeating units present in the copolyester. If the proportion is 100 mole %, then no other repeating units are therefore present.

A particular embodiment of the present invention exists if the proportion of the other dicarboxylic acids is 0 mole %.

A particular embodiment of the present invention exists if the proportion of the other diols is 0 mole %.

A particular embodiment of the present invention exists if the proportion of the layer containing polycarbonate has at least nine times as much mass as the proportion of the layer containing a copolyester.

The multilayered product according to the invention has numerous advantages. In particular, it has the advantage of being chemically resistant. It also has the advantage of possessing high impact strength and notched impact strength. In addition, it may be produced easily and inexpensively. The starting substances are also readily available and inexpensive. In addition, the other positive properties of polycarbonate, e.g. its good optical properties, are not impaired in the multilayered product according to the invention, or only insignificantly.

The multilayered product according to the invention has other advantages compared with the existing systems. The multilayered product according to the invention may be produced by coextrusion. This results in advantages compared with a product made by coating. For example, no solvents evaporate during coextrusion, as is the case with coatings.

In addition, coatings have a limited shelf-life. Coextrusion resins do not have this disadvantage.

In addition, coatings require expensive technology. For example, they require explosion-proof equipment, the recycling of solvents and thus more expensive investments in plants. Coextrusion does not have this disadvantage.

Compared to a product made by lamination, the multilayered product according to the invention has numerous advantages because it may be made by coextrusion.

In lamination, a film must first be produced in a separate step. Coextrusion does not have this disadvantage.

In addition, coextrusion is simple and the necessary know-how is readily accessible. Lamination is more difficult because blisters or deformations of the films may occur.

In addition, sheets with widths of 2.2 metres or more may easily be produced by coextrusion. By contrast, the films for lamination are usually only available in a maximum width of 1.6 metres.

A preferred embodiment of the present invention is the aforesaid multilayered product

wherein,

of the repeating units that are derived from dicarboxylic acids, 90 to 100 mole % are derived from terephthalic acid and 0 to 10 mole % are derived from isophthalic acid and 0 to 10 mole % are derived from other dicarboxylic acids,

and wherein

the sum of the quantity of the repeating units derived from terephthalic acid and derived from isophthalic acid and derived from the other dicarboxylic acids is 100 mole %,

and wherein, of the repeating units that are derived from diols, 60 to 80 mole % are derived from ethylene glycol and 20 to 40 mole % are derived from cyclohexanedimethanol and 0 to 3 mole % are derived from diethylene glycol and 0 to 10 mole % are derived from other diols,

and wherein

the sum of the quantity of the repeating units derived from ethylene glycol and from cyclohexanedimethanol and from diethylene glycol and from other diols is 100 mole %.

Another preferred embodiment of the present invention is the aforesaid multilayered product

wherein, of the repeating units that are derived from dicarboxylic acids,

90 to 100 mole % are derived from terephthalic acid and 0 to 10 mole % are derived from isophthalic acid and 0 to 10 mole % are derived from other dicarboxylic acids,

and wherein

the sum of the quantity of the repeating units derived from terephthalic acid and derived from isophthalic acid and derived from the other dicarboxylic acids is 100 mole %,

and wherein, of the repeating units that are derived from diols,

20 to 40 mole % are derived from ethylene glycol and 60 to 80 mole % are derived from cyclohexanedimethanol and 0 to 3 mole % are derived from diethylene glycol and 0 to 10 mole % are derived from other diols,

and wherein

the sum of the quantity of the repeating units derived from ethylene glycol and from cyclohexanedimethanol and from diethylene glycol and from the other diols is 100 mole %.

According to the invention, those multilayered products in which the layer containing the copolyester additionally contains 1 to 20 wt. % UV absorber are preferred. The UV absorber in this case is preferably selected from the group consisting of Tinuvin® 360, Tinuvin® 1577 and Uvinule 3030. By Tinuvine 360, Tinuvin® 1577 and Uvinule 3030 the following compounds are meant.

Tinuvin® 360 has the following structure:

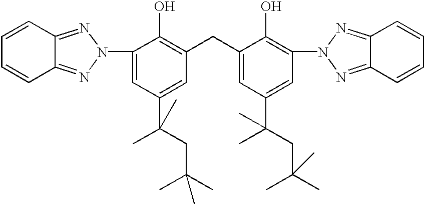

Tinuvin® 1577 has the following structure:

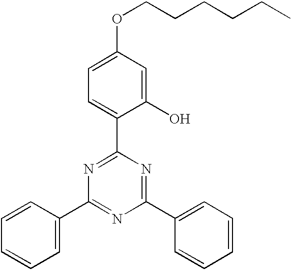

Uvinul® 3030 has the following structure:

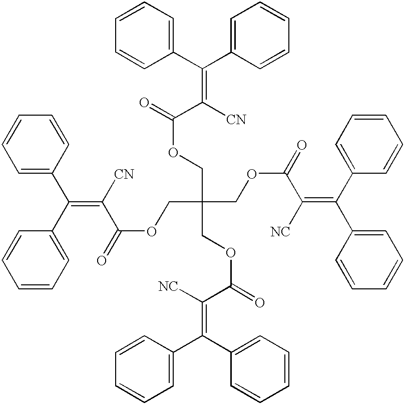

According to the invention, those multilayered products in which the layer containing the copolyester is 10 to 1000 μm thick are preferred. It is preferably 15 to 300 μm thick, and particularly preferably 30 to 100 μm thick.

According to the invention, those multilayered products selected from the group consisting of sheets, pipes and profiles are preferred.

Sheets may, in particular, be solid sheets, which may, in particular, be flat or corrugated. They may also be multi wall sheets, which may, in particular, be flat or corrugated.

Multi wall sheets are intended to mean sheets in which two outer layers are joined together by crosspieces, so that hollow spaces are formed in the interior of the sheet. Twin wall sheets have two outer layers with crosspieces between them. Triple wall sheets have, in addition, a third internal layer, which is parallel to the two outer layers. Multi wall sheets of this type are described e.g. in U.S. Pat. No. 4,707,393 incorporated herein by reference. They are referred to there as multilayered hollow chamber plastic panels. EP-A 0 774 551 also discloses multi wall sheets. In FIG. 1 of EP-A 0 774 551, a triple wall sheet is shown. EP-A 0 054 856 and EP-A 0 741 215 also disclose multi wall sheets.

The multi wall sheets may be twin wall sheets, triple wall sheets, quadruple wall sheets etc. The multi wall sheets may also possess different profiles. In addition, the multi wall sheets may also be corrugated multi wall sheets.

A preferred embodiment of the present invention is a two-layer sheet that includes a layer of polycarbonate and of a layer of the copolyester according to the invention.

Another preferred embodiment of the present invention is a three-layer sheet consisting of a layer of polycarbonate as the middle layer and two layers of the copolyester according to the invention as outer layers.

In a particular embodiment, the multilayered products are transparent.

The copolyester according to the invention may contain cyclohexanedimethanol. This has the following structure:

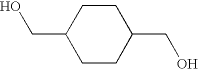

The copolyesters according to the invention may be produced by known methods. The monomers required are known. The monomers and also the copolyesters are commercially available.

The layer containing the copolyester is also referred to below as the coextrusion layer or coex layer. The layer containing the polycarbonate is also referred to as the base layer.

Both the polycarbonate and the copolyester in the multilayered products according to the invention may contain additives.

In particular, the copolyester may contain UV absorbers.

The UV absorbers or mixtures thereof are preferably present in the copolyester layers in concentrations of 0 to 20 wt. %. Concentrations of 0.1 to 20 wt. % are preferred, 2 to 10 wt. % particularly preferred and 3 to 8 wt. % especially preferred. If two or more copolyester layers are present, the proportion of UV absorbers in these layers may vary.

Examples of UV absorbers that may be used according to the invention are described below.

a) Benzotriazole derivatives according to formula (I):

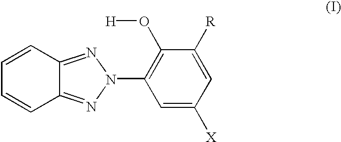

In formula (I), R and X are the same or different and represent H or alkyl or alkylaryl.

X=1,1,3,3-tetramethylbutyl and R═H (commercially available as Tinuvin® 329) or X═tert.-butyl and R═2-butyl (commercially available as Tinuvin® 350) or X═R═1,1-dimethyl-1-phenyl (commercially available as Tinuvin® 234) are preferred here.

These compounds are preferably present in the copolyester layer in a quantity of 0.00001 to 1.5 wt. %, particularly preferably 0.01 to 1.0 wt. %, especially preferably 0.1 to 0.5 wt. %.

b) Dimeric benzotriazole derivatives according to formula (II):

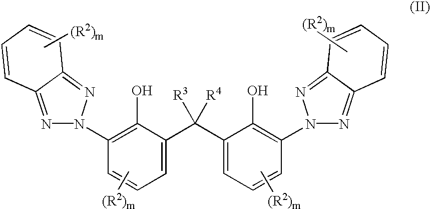

In formula (II), R¹ and R² are the same or different and represent H, halogen, C₁-C₁₀ alkyl, C₅-C₁₀ cycloalkyl, C₇-C₁₃ aralkyl, C₆-C₁₄ aryl, —OR⁵ or —(CO)—O—R⁵ with R⁵═H or C₁-C₄ alkyl.

In formula (II), R³ and R⁴ are also the same or different and represent H, C₁-C₄ alkyl, C₅-C₆ cycloalkyl, benzyl or C₆-C₁₄ aryl.

In formula (II), m represents 1, 2 or 3 and n represents 1, 2, 3 or 4.

It is preferred here that R¹═R³═R⁴═H and n=4 and R²═1,1,3,3-tetramethylbutyl and m=1 (commercially available as Tinuvin® 360).

This compound is preferably present in the copolyester layer in a quantity of 0.00001 to 1.5 wt. %, particularly preferably 0.01 to 1.0 wt. %, and 3 to 10 wt. %, especially preferably 0.1 to 0.5 wt. % and 4 to 8 wt. %.

b1) Dimeric benzotriazole derivatives according to formula (Ill):

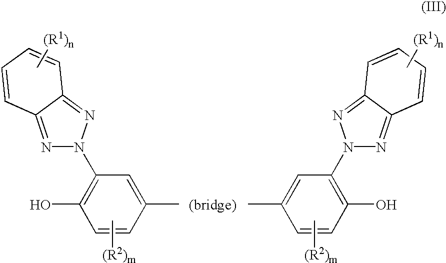

wherein the bridge represents

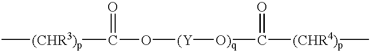

R¹, R², m and n have the meaning given for formula (II), and wherein p is a whole number from 0 to 3, q is a whole number from 1 to 10,

Y equals —CH₂—CH₂—, —(CH₂)₃—, —(CH₂)₄—, —(CH₂)₅—, —(CH₂)₆—, or CH(CH₃)— CH₂— and R³ and R⁴ have the meaning given for formula (II).

It is preferred here that R═H and n=4 and R²═tert.-butyl and m=1 and R² is in the ortho position to the OH group and R³═R⁴═H and p=2 and Y═—(CH₂)₅— and q=1 (Tinuvin® 840).

This compound is preferably present in the copolyester layer in a quantity of 0.00001 to 1.5 wt. % and 2 to 20 wt. %, particularly preferably 0.01 to 1.0 wt. % and 3 to 10 wt. %, especially preferably 0.1 to 0.5 wt. % and 4 to 8 wt. %.

c) Triazine derivatives according to formula (IV):

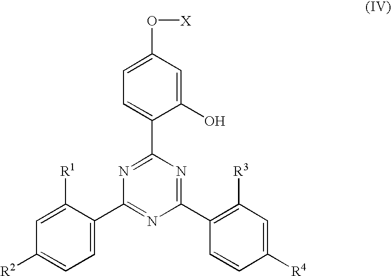

wherein R¹, R², R³ and R⁴ in formula (IV) are the same or different and are H or alkyl or CN or halogen and X equals alkyl.

It is preferred here that R¹═R²═R³═R⁴═H and X═hexyl (commercially available as Tinuvin® 1577) or R¹═R²═R³═R⁴═methyl and X═octyl (commercially available as Cyasorb® UV-1164).

These compounds are preferably present in the copolyester layer in a quantity of 0.00001 to 1.0 wt. % and 1.5 to 10 wt. %, particularly preferably 0.01 to 0.8 wt. % and 2 to 8 wt. %, especially preferably 0.1 to 0.5 wt. % and 3 to 7 wt. %.

d) Triazine derivatives of the following formula (IVa)

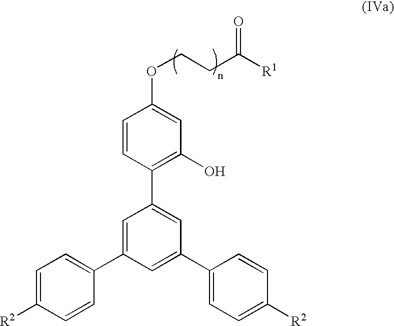

wherein

R¹ represents C, alkyl to C₁₇ alkyl,

R² represents H or C₁ alkyl to C₄ alkyl and

n equals 0 to 20.

These compounds are preferably present in the copolyester layer in a quantity of 0.00001 to 1.0 wt. % and 1.5 to 10 wt. %, particularly preferably 0.01 to 0.8 wt. % and 2 to 8 wt. %, especially preferably 0.1 to 0.5 wt. % and 3 to 7 wt. %.

e) Diaryl cyanoacrylates of formula (V):

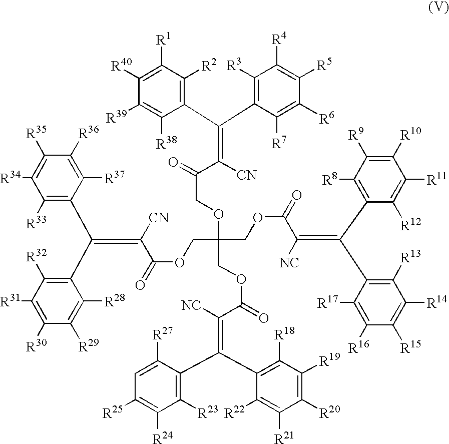

wherein R¹ to R⁴⁰ may be the same or different and represent H, alkyl, CN or halogen.

It is preferred here that R¹ to R⁴⁰═H (commercially available as Uvinul® 3030).

This compound is preferably present in the copolyester layer in a quantity of 0.00001 to 1.0 wt. % and 2 to 20 wt. %, particularly preferably 0.01 to 1.0 wt. % and 3 to 10 wt. %, especially preferably 0.1 to 0.5 wt. % and 4 to 8 wt. %.

The above-mentioned UV absorbers are commercially available.

In addition, besides the UV stabilizers, the copolyester layers and the polycarbonate layers may also contain other conventional processing aids, particularly mold release agents and flow control agents, as well as the stabilizers conventional in polycarbonates, particularly heat stabilizers, as well as dyes and optical brighteners and inorganic pigments.

Polycarbonates for the multilayered products according to the invention are all known polycarbonates.

These are homopolycarbonates, copolycarbonates and thermoplastic polyester carbonates.

They preferably have weight average molecular weights \overline{M}_{W} of 18,000 to 40,000, preferably 26,000 to 36,000 and particularly 28,000 to 35,000, determined by measuring the relative solution viscosity in dichloromethane or in mixtures of equal quantities by weight of phenol/o-dichlorobenzene (5 g polymer dissolved in 1 l solvent, measured at 25° C.) calibrated by light scattering.

With regard to the production of polycarbonates, reference is made, by way of an example, to “Schnell, Chemistry and Physics of Polycarbonates, Polymer Reviews, vol. 9, lnterscience Publishers, New York, London, Sydney 1964”, and to “D. C. PREVORSEK, B. T. DEBONA and Y. KESTEN, Corporate Research Center, Allied Chemical Corporation, Moristown, N.J. 07960, ‘Synthesis of Poly(ester)carbonate Copolymers’ in Journal of Polymer Science, Polymer Chemistry Edition, vol. 19, 75-90 (1980)”, and to “D. Freitag, U. Grigo, P. R. Müller, N. Nouvertne, BAYER A G, ‘Polycarbonates’ in Encyclopedia of Polymer Science and Engineering, vol.11, second edition, 1988, pages 648-718” and finally to “Dres. U. Grigo, K. Kircher and P. R. Müller ‘Polycarbonate’ in Becker/Braun, Kunststoff Handbuch, vol. 3/1, Polycarbonate, Polyacetale, Polyester, Celluloseester, Carl Hanser Verlag Munich, Vienna 1992, pages 117-299”.

The production of the polycarbonates preferably takes place by the interfacial polycondensation process or the melt transesterification process and is described below using the interfacial polycondensation process as an example.

Compounds preferably to be employed as starting compounds are bisphenols of the general formula

HO—Z—OH,

wherein Z is a divalent organic radical with 6 to 30 carbon atoms, containing one or more aromatic groups.

Examples of these compounds are bisphenols belonging to the group of the dihydroxydiphenyls, bis(hydroxyphenyl)alkanes, indane bisphenols, bis(hydroxyphenyl) ethers, bis(hydroxyphenyl) sulfones, bis(hydroxyphenyl) ketones and α,α′-bis(hydroxyphenyl) diisopropylbenzenes.

Particularly preferred bisphenols belonging to the above-mentioned groups of compounds are bisphenol A, tetraalkyl bisphenol A, 4,4-(meta-phenylenediisopropyl)diphenol (bisphenol M), 4,4-(para-phenylenediisopropyl)diphenol, 1,1-bis(4-hydroxyphenyl)-3,3,5-trimethylcyclohexane (bisphenol-TMC) and optionally mixtures thereof.

The bisphenol compounds to be used according to the invention are preferably reacted with carbonic acid compounds, particularly phosgene or, in the melt transesterification process, with diphenyl carbonate or dimethyl carbonate.

Polyester carbonates are preferably obtained by reacting the bisphenols already mentioned, at least one aromatic dicarboxylic acid and optionally carbonic acid equivalents. Suitable aromatic dicarboxylic acids are e.g. phthalic acid, terephthalic acid, isophthalic acid, 3,3′- or 4,4′-diphenyldicarboxylic acid and benzophenonedicarboxylic acids. A portion, up to 80 mole %, preferably 20 to 50 mole %, of the carbonate groups in the polycarbonates may be replaced by aromatic dicarboxylic acid ester groups.

Inert organic solvents used in the interfacial polycondensation process are e.g. dichloromethane, the various dichloroethanes and chloropropane compounds, tetrachloromethane, trichloromethane, chlorobenzene and chlorotoluene, with chlorobenzene, dichloromethane or mixtures of dichloromethane and chlorobenzene preferably being used.

The interfacial polycondensation reaction may be accelerated by catalysts such as tertiary amines, particularly N-alkylpiperidines or onium salts. Tributylamine, triethylamine and N-ethylpiperidine are preferably used. In the case of the melt transesterification process, the catalysts mentioned in DE-A 4 238 123 are preferably used.

The polycarbonates may be branched in a known manner by using small quantities of branching agents. Some suitable branching agents are: phloroglucinol, 4,6-dimethyl-2,4,6-tri(4-hydroxyphenyl)heptene-2; 4,6-dimethyl-2,4,6-tri(4-hydroxyphenyl)heptane; 1,3,5-tri(4-hydroxyphenyl)benzene; 1,1,1-tri(4-hydroxyphenyl)ethane; tri(4-hydroxyphenyl)phenylmethane; 2,2-bis[4,4-bis(4-hydroxyphenyl)cyclo-hexyl]propane; 2,4-bis(4-hydroxyphenylisopropyl)phenol; 2,6-bis(2-hydroxy-5′-methyl benzyl)-4-methylphenol; 2-(4-hydroxyphenyl)-2-(2,4-di-hydroxyphenyl)propane; hexa(4-(4-hydroxyphenylisopropyl)phenyl) ortho-terephthalate; tetra(4-hydroxyphenyl)methane; tetra(4-(4-hydroxyphenyl-isopropyl)phenoxy)methane; α,α′,α″-tris (4-hydroxyphenyl)-1,3,5-triisopropylbenzene; 2,4-dihydroxybenzoic acid; trimesic acid; cyanuric chloride; 3,3-bis(3-methyl-4-hydroxyphenyl)-2-oxo-2,3-dihydroindole; 1,4-bis(4′,4″-dihydroxytriphenyl)methyl)benzene and particularly 1,1,1-tri(4-hydroxyphenyl)ethane and bis(3-methyl-4-hydroxyphenyl)-2-oxo-2,3-dihydroindole.

The 0.05 to 2 mole %, based on diphenols used, of branching agents or mixtures of the branching agents that may optionally be incorporated may be fed in together with the diphenols or else added at a later stage of the synthesis.

Phenols, such as phenol, alkylphenols, such as cresol and 4-tert.-butylphenol, chlorophenol, bromophenol, cumylphenol or mixtures thereof are preferably used as chain terminators in quantities of 1 to 20 mole %, preferably 2 to 10 mole % per mole of bisphenol. Phenol, 4-tert.-butylphenol and cumylphenol are preferred.

Chain terminators and branching agents may be added to the syntheses separately or else together with the bisphenol.

The production of the polycarbonates by the melt transesterification process is described in DE-A 42 38 123.

Polycarbonates that are preferred according to the invention are the homopolycarbonate based on bisphenol A, the homopolycarbonate based on 1,1-bis(4-hydroxyphenyl)-3,3,5-trimethylcyclohexane and the copolycarbonates based on the two monomers bisphenol A and 1,1-bis(4-hydroxyphenyl)-3,3,5-trimethylcyclohexane and the copolycarbonates based on the two monomers bisphenol A and 4,4′-dihydroxydiphenyl (DOD).

The homopolycarbonate based on bisphenol A is particularly preferred.

The polycarbonate may contain stabilizers. Suitable stabilizers are e.g. phosphines, phosphites or stabilizers containing Si and other compounds described in EP-A 0 500 496. Triphenyl phosphites, diphenyl alkyl phosphites, phenyl dialkyl phosphites, tris(nonylphenyl) phosphite, tetrakis(2,4-di-tert.-butylphenyl)-4,4′-biphenylene diphosphonite and triaryl phosphite may be mentioned as examples. Triphenylphosphine and tris(2,4-di-tert.-butylphenyl) phosphite are particularly preferred.

These stabilizers may be present in all layers of the multilayered product according to the invention, i.e. both in the so-called base and in the so-called coex layer or layers. Different additives or concentrations of additives may be present in each layer.

Furthermore, the multilayered product according to the invention may contain 0.01 to 0.5 wt. % of the esters or partial esters of monohydric to hexahydric alcohols, particularly of glycerol, pentaerythritol or of Guerbet alcohols.

Monohydric alcohols are e.g. stearyl alcohol, palmityl alcohol and Guerbet alcohols.

A dihydric alcohol is e.g. glycol.

A trihydric alcohol is e.g. glycerol.

Tetrahydric alcohols are e.g. pentaerythritol and mesoerythritol.

Pentahydric alcohols are e.g. arabitol, ribitol and xylitol.

Hexahydric alcohols are e.g. mannitol, glucitol (sorbitol) and dulcitol.

The esters are preferably the monoesters, diesters, triesters, tetraesters, pentaesters and hexaesters or mixtures thereof, particularly random mixtures, of saturated, aliphatic C₁₀ to C₃₆ monocarboxylic acids and optionally hydroxymonocarboxylic acids, preferably with saturated, aliphatic C₁₄ to C₃₂ monocarboxylic acids and optionally hydroxymonocarboxylic acids.

The commercially available fatty acid esters, particularly of pentaerythritol and glycerol, may contain <60% of different partial esters as a result of their production.

Saturated, aliphatic monocarboxylic acids with 10 to 36 C atoms are e.g. capric acid, lauric acid, myristic acid, palmitic acid, stearic acid, hydroxystearic acid, arachidic acid, behenic acid, lignoceric acid, cerotic acid and montanic acids.

Preferred saturated, aliphatic monocarboxylic acids with 14 to 22 C atoms are e.g. myristic acid, palmitic acid, stearic acid, hydroxystearic acid, arachidic acid and behenic acid.

Saturated, aliphatic monocarboxylic acids such as palmitic acid, stearic acid and hydroxystearic acid are particularly preferred.

The saturated, aliphatic C₁₀ to C₃₆ carboxylic acids and the fatty acid esters are either known per se from the literature or may be produced by processes that are known from the literature. Examples of pentaerythritol fatty acid esters are those of the particularly preferred monocarboxylic acids mentioned above.

Esters of pentaerythritol and of glycerol with stearic acid and palmitic acid are particularly preferred.

Esters of Guerbet alcohols and of glycerol with stearic acid and palmitic acid and optionally hydroxystearic acid are also particularly preferred.

These esters may be present both in the base and in the coex layer or layers. Different additives or concentrations may be present in each layer.

The multilayered products according to the invention may contain antistatic agents.

Examples of antistatic agents are cationic compounds, e.g. quaternary ammonium, phosphonium or sulfonium salts, anionic compounds, e.g. alkyl sulfonates, alkyl sulfates, alkyl phosphates, carboxylates in the form of alkali or alkaline earth metal salts, non-ionogenic compounds, e.g. polyethylene glycol esters, polyethylene glycol ethers, fatty acid esters and ethoxylated fatty amines. Preferred antistatic agents are non-ionogenic compounds.

These antistatic agents may be present both in the base and in the coex layer or layers. Different additives or concentrations may be present in each layer. They are preferably used in the coex layer or layers.

The multilayered products according to the invention may contain organic dyes, inorganic pigments, fluorescent dyes and particularly preferably optical brighteners.

These coloring agents may be present both in the base and in the coex layer or layers. Different additives or concentrations may be present in each layer.

All molding compositions used for the production of the multilayered products according to the invention, their feedstocks and solvents may be contaminated with corresponding impurities from their production and storage, the aim being to work with the cleanest possible starting substances.

The individual components may be mixed in a known manner, either consecutively or simultaneously and either at room temperature or at elevated temperature.

The incorporation of the additives into the molding compositions according to the invention, particularly of the UV absorbers and other additives mentioned above, preferably takes place in a known manner by mixing polymer granules with the additives at temperatures of about 200 to 330° C. in conventional units such as internal mixers, single screw extruders and double-shaft extruders, e.g. by melt compounding or melt extrusion or by mixing the solutions of the polymer with solutions of the additives and subsequently evaporating the solvents in a known manner. The proportion of the additives in the molding composition may be varied within broad limits and depends on the desired properties of the molding composition. The total proportion of the additives in the molding composition is preferably up to about 20 wt. %, preferably 0.2 to 12 wt. %, based on the weight of the molding composition.

The incorporation of the UV absorbers into the molding compositions may also take place e.g. by mixing solutions of the UV absorbers and optionally other aforementioned additives with solutions of the plastics in suitable organic solvents, such as CH₂Cl₂, haloalkanes, haloaromatics, chlorobenzene and xylenes. The substance mixtures are then preferably homogenised in a known manner by extrusion; the solution mixtures are preferably discharged in a known manner, e.g. compounded, by evaporation of the solvent and subsequent extrusion.

As demonstrated by the examples, the use of the coextrusion molding compositions according to the invention offers a significant advantage on any polycarbonate molding compositions as base material.

The processing of the multilayered products according to the invention, e.g. by thermoforming or by surface treatments, such as e.g. providing with scratch-resistant paints, water-spreading layers and similar, is possible and the products made by these processes are also provided by the present invention.

Coextrusion per se is known from the literature (cf. e.g. EP-A 0 110 221 and EP-A 0 110 238). In the present case, the process is preferably as follows. Extruders to produce the core layer and outer layer(s) are attached to a coextrusion adapter. The adapter is designed in such a way that the melt forming the outer layer(s) is applied as a thin layer adhering to the melt of the core layer. The multilayered melt strand thus produced is then brought into the desired shape (multi wall or solid sheet) in the subsequently attached die. The melt is then cooled in a known manner under controlled conditions by calendering (solid sheet) or vacuum calibration (multi wall sheet) and then cut into lengths. After the calibration, a conditioning oven may optionally be attached to eliminate stresses. Instead of the adapter attached before the die, the die itself may also be designed in such a way that the melts are brought together there.

The invention is further explained by the following examples, without being restricted to these. The examples according to the invention only reflect preferred embodiments of the present invention.

### EXAMPLES

3 mm solid sheets A and B, were obtained from the following molding compositions. As the base material for the sheets A, B, C and D, Makrolon® 3103 (linear bisphenol A polycarbonate from Bayer A G, Leverkusen with a melt flow index according to ISO 1133 at 300° C. and 1.2 kg load, (MFR) of 6.5 g/10 min was used.

This was coextruded in cases A and B with the compounds listed in the table based on Makrolon® 3100 (linear bisphenol A polycarbonate from Bayer A G, Leverkusen with MFR 6.5 g/10 and in cases C and D with the compound listed in the table based on Spectar® 14471 (copolyester of terephthalic acid with cyclohexanedimethanol and ethylene glycol and diethylene glycol from the Eastman Chemical Company). Spectar® 14471 contains 65 to 71 mole % ethylene glycol and 26 to 35 mole % cyclohexanedimethanol and 1.5 to 3 mole % diethylene glycol and 100 mole % terephthalic acid.

The thickness of the coex layer was about 100 μm in each case.

| Sheet | Support material | Tinuvin 1577*) | Mold release agent |
|---|---|---|---|
| A | Makrolon 3100 | 0% | 0% |
| B | Makrolon 3100 | 5% | 0.25% PETS**) |
| C | Spectar 14471 | 0% | 0% |
| D | Spectar 14471 | 5% | 0.25% PETS**) |

*)2-(4,6-diphenyl-1,3,5-triazin-2-yl)-5-hexyloxy)phenol: commercially available as Tinuvin 1577 from Ciba Specialitätenchemie, Lampertheim, Germany
**)Pentaerythritol tetrastearate, commercially available as Loxiol VPG 861 from Cognis, Düsseldorf, Germany

The machines and equipment used for the production of multilayered solid sheets are described below. They comprise:

the main extruder with a screw having a length of 33 D and a diameter of 70 mm with venting

a coextruder for applying the outer layer with a screw having a length of 25 D and a diameter of 35 mm

a special sheet coextrusion die 350 mm wide

a polishing calender

a roller table

a take-off unit

a cut-off device (saw)

a stacking table.

The polycarbonate granules of the base material were fed into the feed hopper of the main extruder and the PETG coextrusion material into that of the coextruder. Each material was melted and conveyed in the respective barrel/screw plasticising system. The two material melts were brought together in the coextrusion die and, after leaving the die and cooling in the calender, they formed a composite. The other equipment was used for transporting, cutting off and stacking the extruded sheets.

The sheets obtained were then tested for their resistance to various chemicals by the following test:

A sheet measuring 110 mm×35 mm×3 mm had four strips of double-sided adhesive tape (5 mm wide) stuck on to it in such a way that a chamber measuring 4.5 cm×2.5 cm was formed (the four strips of adhesive tape forming the “walls” of the chamber and the sheet forming the bottom). After clamping on to an outer fibre strain template (reference: “0.99”; outer fibre strain 1.5% for 3 mm thick sheets according to DIN 53449 part 3), a piece of cotton measuring 3 cm×1 cm impregnated with the test medium was placed in the middle of the chamber and sealed with aluminium foil. Because the sheets were wider than the template, the beginning and the course of the crack formation could readily be observed through the reverse.

The following table shows that sheets coextruded with the coextrusion molding compositions according to the invention (C and D) possess better chemical resistance than the comparative sheets A and B.

| | Exposure | | | | |
|---|---|---|---|---|---|
| | time | Sheet A | Sheet B | Sheet C | Sheet D |
| Test with | 2 hours | Several | Several | No cracks | No cracks |
| cyclohexane | | cracks | cracks | | |
| Test with | 2 hours | Many | Many | A few fine | A few fine |
| perfume 1) | | severe | severe | cracks | cracks |
| | | cracks | cracks | | |
| Test with | 6 hours | A few fine | A few fine | No cracks | No cracks |
| Rea-Clean 2) | | cracks | cracks | | |

1) Jil Sander Woman III
2) Bio cleaner from Chemutec GmbH, Bruchköbel

Jil Sander Woman III contains, among other things, water and ethanol. Essential oils are also present.

The bio cleaner contains, among other things, surfactants, salts of organic acids and solubility promoters.

The test with cyclohexane is important because cyclohexane is used as a solvent in paints.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

What is claimed is:

1. A multilayered article of manufacture comprising a layer containing polycarbonate and a layer containing a copolyester, wherein the repeating units of the copolyester are derived from dicarboxylic acids and from diols, and wherein, of the repeating units that are derived from dicarboxylic acids,
50 to 100% are derived from terephthalic acid and
0 to 50% are derived from isophthalic acid and
0 to 10% are derived from other dicarboxylic acids, and wherein the sum of the proportions of the repeating units derived from terephthalic acid, isophthalic acid and the other dicarboxylic acids is 100%, and where the percents relate to the molar amount of units derived from dicarboxylic acids,
and wherein, of the repeating units that are derived from diols,
0 to 97% are derived from ethylene glycol and
0 to 97% are derived from cyclohexanedimethanol and
0 to 3% are derived from diethylene glycol and
0 to 10% are derived from other diols,
and wherein the sum of the proportions of the repeating units
derived from ethylene glycol, cyclohexanedimethanol, diethylene glycol and other diols is 100% and where the percents relate to the molar amount of units derived from diols.

2. A multilayered article of manufacture comprising a layer containing polycarbonate and a layer containing a copolyester, wherein the repeating units of the copolyester are derived from dicarboxylic acids and from diols, and wherein, of the repeating units that are derived from dicarboxylic acids,
90 to 100% are derived from terephthalic acid and
0 to 10% are derived from isophthalic acid and
0 to 10% are derived from other dicarboxylic acids, and wherein the sum of the proportions of the repeating units derived from terephthalic acid, isophthalic acid and the other dicarboxylic acids is 100%, and where the percents relate to the molar amount of units derived from dicarboxylic acids,
and wherein, of the repeating units that are derived from diols,
60 to 80% are derived from ethylene glycol and
20 to 40% are derived from cyclohexanedimethanol and
0 to 3% are derived from diethylene glycol and
0 to 10% are derived from other diols,
and wherein the sum of the proportions of the repeating units
derived from ethylene glycol, cyclohexanedimethanol, diethylene glycol and other diols is 100% and where the percents relate to the molar amount of units derived from diols.

3. A multilayered article of manufacture comprising a layer containing polycarbonate and a layer containing a copolyester, wherein the repeating units of the copolyester are derived from dicarboxylic acids and from diols, and wherein, of the repeating units that are derived from dicarboxylic acids,
90 to 100% are derived from terephthalic acid and
0 to 10% are derived from isophthalic acid and
0 to 10% are derived from other dicarboxylic acids, and wherein the sum of the proportions of the repeating units derived from terephthalic acid, isophthalic acid and the other dicarboxylic acids is 100%, and where the percents relate to the molar amount of units derived from dicarboxylic acids,
and wherein, of the repeating units that are derived from diols,
20 to 40% are derived from ethylene glycol and
60 to 80% are derived from cyclohexanedimethanol and
0 to 3% are derived from diethylene glycol and
0 to 10% are derived from other diols,
and wherein the sum of the proportions of the repeating units
derived from ethylene glycol, cyclohexanedimethanol, diethylene glycol and other diols is 100% and where the percents relate to the molar amount of units derived from diols.

4. The multilayered article of manufacture according to claim 1 wherein the polycarbonate is selected from the group consisting of a homopolycarbonate based on bisphenol A, a homopolycarbonate based on 1,1-bis(4-hydroxyphenyl)-3,3,5-trimethylcyclohexane, a copolycarbonate based on bisphenol A and 1,1-bis(4-hydroxyphenyl)-3,3,5-trimethylcyclohexane and a copolycarbonate based on bisphenol A and 4,4′-dihydroxydiphenyl.

5. The multilayered article of manufacture according to claim 4, wherein the polycarbonate is the homopolycarbonate based on bisphenol A.

6. The multilayered article of manufacture according to claim 1 selected from the group consisting of sheets, pipes and profiles.

7. The multilayered article of manufacture according to claim 1 wherein the layer containing the copolyester additionally contains 1 to 20% of UV absorber, the percent being relative to the weight of the layer.

8. The multilayered article of manufacture according to claim 7, wherein the UV absorber is selected from the group consisting of

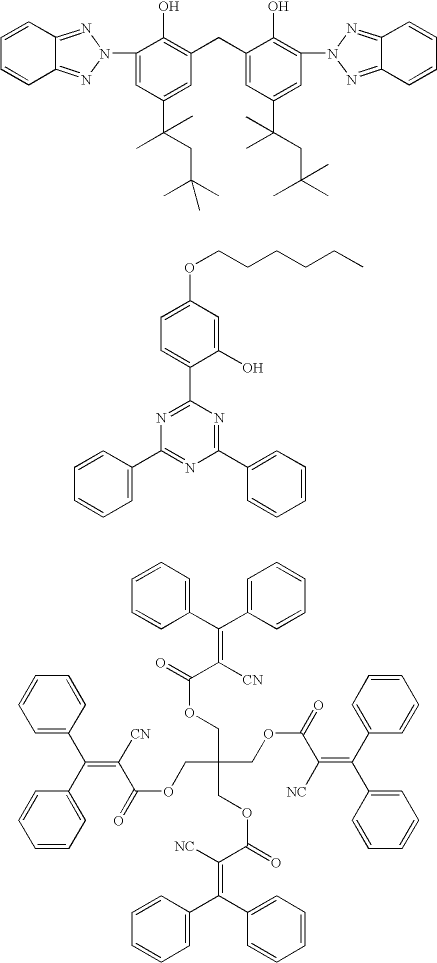

9. The multilayered article of manufacture according to claim 1 wherein the layer containing the copolyester is 10 to 1000 μm thick.

10. A process for the production of the multilayered article of manufacture of claim 1 comprising coextruding the layer containing polycarbonate and the layer containing the copolyester.
